(19) United States
(12) Patent Application Publication
(10) Pub. No.: US 2015/0105242 A1
(43) Pub. Date: Apr. 16, 2015

(54) Influence of Base Metal Loadings on TWC Performance of ZPGM Catalysts

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Ventura, CA (US)

(21) Appl. No.: 14/530,347

(22) Filed: Oct. 31, 2014

Related U.S. Application Data
(63) Continuation-in-part of application No. 13/849,169, filed on Mar. 22, 2013, now Pat. No. 8,858,903.

(51) Int. Cl. B01J 23/889; B01J 23/10

(52) U.S. Cl. CPC B01J 23/8892; B01J 23/10
USPC 502/302; 502/324

(57) ABSTRACT

Influence of a plurality of base metal loadings on TWC performance of ZPGM catalysts for TWC applications is disclosed. ZPGM catalyst samples are prepared and configured with washcoat on ceramic substrate, overcoat including doped Zirconia support oxide, and impregnation layer of Cu—Mn spinel with different base metal loadings. Testing of ZPGM catalyst samples including variations of base metal loadings is developed under isothermal steady state sweep test condition to evaluate the influence of variations of base metal loadings on TWC performance in NO_{X} conversion. As a result of increasing Cu—Mn base metal loadings, improvements of lean NO_{X} conversion and oxygen storage capacity may be realized at higher base metal loading ratios. The ZPGM catalyst samples exhibiting higher NO_{X} conversion and OSC are compared with commercial PGM catalyst samples under lean condition. OSC isothermal oscillating tests are carried out to confirm the increase in OSC property of samples, as well as TWC performance, both correlated to increasing base metal loadings that may further improve TWC performance.

### CROSS-REFERENCE TO RELATED APPLICATIONS

This application is a continuation-in-part of U.S. patent application Ser. No. 13/849,169, filed Mar. 23, 2013, entitled “Methods for Oxidation and Two-way and Three-way ZPGM Catalyst Systems and Apparatus Comprising Same,” now U.S. Pat. No. 8,858,903, issued Oct. 14, 2014, which is incorporated herein by reference as if set forth in its entirety.

### BACKGROUND

1. Field of the Disclosure

This disclosure relates generally to catalyst materials, and more particularly to the effect of Cu—Mn loadings on three-way catalyst (TWC) performance of Zero-PGM (ZPGM) catalyst systems.

2. Background Information

The behavior of catalyst systems may be controlled by the properties of the slurry characteristics of materials used in appropriate loadings. Different catalyst properties can be achieved in terms of base metal loadings such that a coating of sufficient loading may provide improved active sites for catalytic performance.

One of the major problems with manufacturing of catalyst systems may be achieving the appropriate metal loading for catalytic performance. The metal loadings employed may fail to provide catalyst layers capable of producing appropriate TWC performance. A plurality of factors which can affect performance are suitable formulation and loading of ZPGM materials, and adequate loading of washcoat and overcoat, amongst others.

Current TWC systems significantly increase the efficiency of conversion of pollutants and, thus, aid in meeting emission standards for automobiles and other vehicles. In order to achieve an efficient three-way conversion of the toxic components in the exhaust gas, conventional TWC includes large quantities of PGM material, such as platinum, palladium, and rhodium, amongst other, dispersed on suitable oxide carriers. Because catalysts including PGM materials provide a very high activity for the conversion of NOₓ, they are typically considered to be essential component of TWC systems.

Recent environmental concerns for a catalyst's high performance have increased the focus on the operation of a TWC at the end of its lifetime. Catalytic materials used in TWC applications have also changed, and the new materials have to be thermally stable under the fluctuating exhaust gas conditions. The attainment of the requirements regarding the techniques to monitor the degree of the catalyst's deterioration/deactivation demands highly active and thermally stable catalysts. As NO emission standards tighten and PGMs become scarce with small market circulation volume, constant fluctuations in price, and constant risk to stable supply, amongst others, there is an increasing need for new TWC catalyst compositions which may not require PGM and may be able to maintain efficient TWC of exhaust byproducts. There also remains a need for methods of producing such TWC catalyst formulations using the appropriate metal loadings of non-PGM material.

According to the foregoing, there may be a need to provide catalytic properties which may significantly depend on metal loadings to obtain, under some conditions, high dispersion metal components systems for PGM-free catalyst systems which may be manufactured cost-effectively, such that TWC performance of ZPGM catalyst systems may be improved by realizing suitable PGM-free catalytic layers.

### SUMMARY

For catalysts, in a highly dispersed and active form aiming at improving catalyst activity, a more effective utilization of the PGM-free catalyst materials may be achieved when expressed as a function of base metal loadings. A plurality of coating process techniques may be employed for the incorporation of catalytically active species onto support oxide materials, which are influential to the coating properties. A process for coating of sufficient loading may provide improved active sites for catalytic performance. In present disclosure, impregnation technique may be employed to incorporate active catalyst material and to describe important factors which may derive from variations of base metal loadings and their influence on the activity, selectivity, and durability of the catalyst system.

According to embodiments in present disclosure, a catalyst system may include at least a substrate, a washcoat (WC) layer, an overcoat (OC) layer and an impregnation layer. A plurality of catalyst systems may be configured to include an alumina-based WC layer coated on a suitable ceramic substrate, an overcoat layer (OC) layer of support oxide material, such as doped ZrO₂, and an impregnation (IMP) layer including Cu—Mn spinel with a plurality of base metal loadings.

According to embodiments in present disclosure, impregnation technique may be used for applying an impregnation (IMP) layer including Cu_{1.0}Mn_{2.0}O₄ spinel of varied loadings on an OC layer of doped ZrO₂. In present disclosure, Praseodymium-Zirconium support oxide may be used.

Subsequently, fresh ZPGM catalyst samples may undergo testing to measure/analyze influence of variations of base metal loadings on TWC performance. Additionally, TWC performance for most effective ZPGM catalyst samples may be compared with TWC performance of commercial PGM catalysts including oxygen storage materials (OSM).

The NO/CO cross over R-value of prepared fresh ZPGM catalyst samples, per variations of base metal loadings employed in present disclosure, may be determined and compared by performing isothermal steady state sweep test, which may be carried out at a selected inlet temperature using an 11-point R-value from rich condition to lean condition, at a plurality of space velocities. Results from isothermal steady state test may be compared under lean condition and rich condition close to stoichiometric condition to show the influence of base metal loadings on TWC performance.

The oxygen storage capacity (OSC) property of disclosed ZPGM catalysts, per variations of base metal loadings, may be determined using CO and O₂ pulses under isothermal oscillating condition, referred as OSC test, to determine O₂ and CO delay times, which may also verify influence on catalyst activity that may derive from varying base metal loadings of Cu and Mn to prepare impregnation layer of Cu_{1.0}Mn_{2.0}O₄ spinel.

It may also be found from present disclosure that although the catalytic activity, and thermal and chemical stability of a catalyst during real use may be affected by factors, such as the chemical composition of the catalyst, the OSC property of disclosed ZPGM catalyst systems may provide an indication that under lean condition and rich condition close to stoichiometric condition, the chemical composition of disclosed ZPGM catalysts may be more efficient operationally-wise, and from a catalyst manufacturer's viewpoint, an essential advantage given the economic factors involved.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 represents a catalyst system configuration for fresh ZPGM catalyst samples, including alumina-based washcoat on substrate, overcoat with doped ZrO₂, and impregnation layer of Cu—Mn spinel at varied base metal loadings, according to an embodiment.

FIG. 2 depicts NO_{X} conversion comparison for fresh ZPGM catalyst samples prepared by impregnation of stoichiometric Cu—Mn spinel of different base metal loadings, under isothermal steady state sweep condition at inlet temperature of about 450° C. and space velocity (SV) of about 40,000 h⁻¹, according to an embodiment.

FIG. 3 illustrates NO_{X} conversion comparison under lean condition for fresh ZPGM catalyst samples prepared by impregnation of Cu—Mn spinel at selected base metal loading and commercial PGM catalyst, under isothermal steady state sweep condition at inlet temperature of about 450° C. and space velocity (SV) of about 40,000 h⁻¹, according to an embodiment.

FIG. 4 depicts OSC isothermal oscillating test results at 575° C. for fresh ZPGM catalyst samples prepared by impregnation of Cu—Mn spinel at selected base metal loading, according to an embodiment.

FIG. 5 shows comparison of O₂ delay time results from OSC isothermal oscillating tests performed at 575° C., for fresh ZPGM catalyst samples prepared by impregnation of stoichiometric Cu—Mn spinel of different base metal loadings, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Milling” refers to the operation of breaking a solid material into a desired grain or particle size.

“Impregnation” refers to the process of imbuing or saturating a solid layer with a liquid compound or the diffusion of some element through a medium or substance.

“Calcination” refers to a thermal treatment process applied to solid materials, in presence of air, to bring about a thermal decomposition, phase transition, or removal of a volatile fraction at temperatures below the melting point of the solid materials.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Stoichiometric condition” refers to the condition when the oxygen of the combustion gas or air added equals the amount for completely combusting the fuel.

“Rich condition” refers to exhaust gas condition with an R-value above 1.

“Lean condition” refers to exhaust gas condition with an R-value below 1.

“Air/Fuel ratio” or A/F ratio” refers to the weight of air divided by the weight of fuel.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean and to release it at rich condition.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

### DESCRIPTION OF THE DRAWINGS

The present disclosure may provide material compositions including stoichiometric Cu—Mn spinel at varied loadings on support oxide and their influence on TWC performance to develop suitable catalytic layers, which may ensure the identification of base metal loadings capable of providing high chemical reactivity and thermal and mechanical stability. Aspects that may be treated in present disclosure may show improvements in the process for overall catalytic conversion capacity for a plurality of ZPGM catalysts which may be suitable for TWC applications.

ZPGM Catalyst Configuration, Material Composition, and Preparation

As catalyst performance may be translated into the physical catalyst structure, different materials compositions may be formulated and prepared, including stoichiometric Cu—Mn spinel of different base metal loadings and support oxide materials, to determine the influence of the variations of base metal loadings on TWC performance.

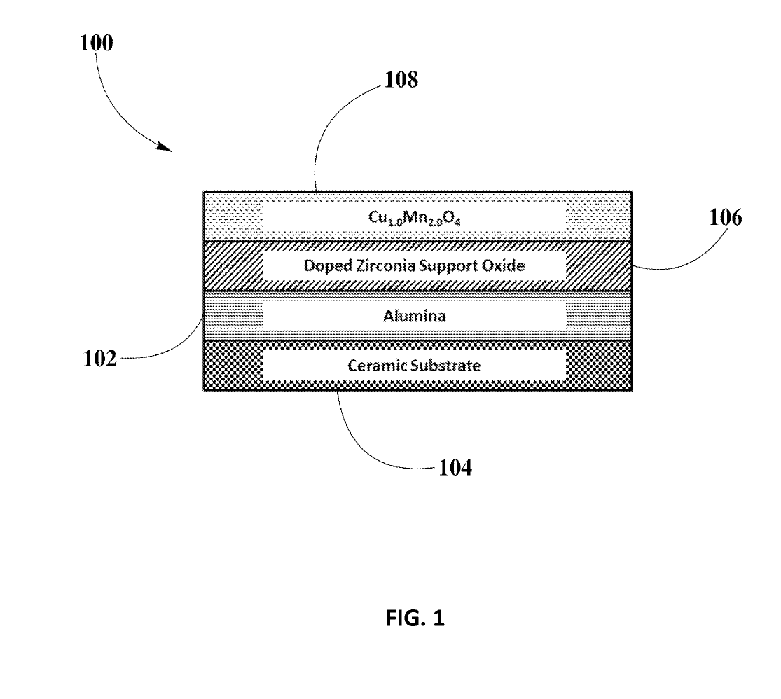

FIG. 1 shows a catalyst configuration 100 for fresh ZPGM catalyst samples, including alumina, Cu_{1.0}Mn_{2.0}O₄ spinel of different base metal loadings, and support oxide materials, which may be prepared employing a suitable coating process, as known in the art, according to an embodiment. In present disclosure support oxide material may be doped ZrO₂.

In this configuration washcoat (WC) layer 102 may be an alumina-based washcoat, coated on suitable ceramic substrate 104.

Impregnation technique may be used for applying an impregnation (IMP) layer 108 of Cu_{1.0}Mn_{2.0}O₄ spinel of different base metal loadings on overcoat (OC) layer 106 of doped ZrO₂, which may be coated on alumina-based WC layer 102 on ceramic substrate 104. In present disclosure IMP layer 108 including Cu_{1.0}Mn_{2.0}O₄ spinel of different based metal loadings may be applied on OC layer 106 of Pr₆O₁₁—ZrO₂ support oxide, coated on alumina-based WC layer 102 on ceramic substrate 104.

The effect of the plurality of base metal loadings of Cu—Mn may be verified preparing fresh ZPGM catalyst samples, according to catalyst formulations in present disclosure.

The NO/CO cross over R-value of prepared fresh ZPGM catalyst samples, per variations of base metal loadings employed in present disclosure, may be determined and compared by performing isothermal steady state sweep test. The isothermal steady state sweep test may be developed at a selected inlet temperature using an 11-point R-value from rich condition to lean condition at a plurality of space velocities. Results from isothermal steady state test may be compared under lean condition and rich condition close to stoichiometric condition to show the influence of base metal loadings on TWC performance. Additionally, catalytic activity in NO_{X} conversion of selected fresh ZPGM catalyst samples, prepared per variations of base metal loadings of Cu and Mn, may be compared with activity in NO_{X} conversion of fresh samples of commercial PGM catalyst.

The oxygen storage capacity (OSC) property of disclosed fresh ZPGM catalyst samples, per variations of base metal loadings, may be determined using CO and O₂ pulses under isothermal oscillating condition, referred as OSC test, to determine O₂ and CO delay times and to verify the influence on activity that may result from variations of the base metal loadings of Cu and Mn.

Isothermal Steady State Sweep Test Procedure

The isothermal steady state sweep test may be carried out employing a flow reactor at inlet temperature of about 450° C., and testing a gas stream at 11-point R-values from about 2.00 (rich condition) to about 0.80 (lean condition) to measure the CO, NO, and HC conversions. The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

OSC Isothermal Oscillating Test Procedure

Testing of the OSC property of fresh ZPGM catalyst samples, from variations of base metal loadings of Cu and Mn, may be performed under isothermal oscillating condition to determine O₂ and CO delay times, the time required to reach to 50% of the O₂ and CO concentration in feed signal, used as parameters for performance of the ZPGM catalyst samples.

The OSC isothermal test may be carried out at temperature of about 575° C. with a feed of either O₂ with a concentration of about 4,000 ppm diluted in inert nitrogen (N₂), or CO with a concentration of about 8,000 ppm of CO diluted in inert N₂. The OSC isothermal oscillating test may be performed in a quartz reactor using a space velocity (SV) of 60,000 hr⁻¹, ramping from room temperature to isothermal temperature of about 575° C. under dry N₂. At the temperature of about 575° C., OSC test may be initiated by flowing O₂ through the catalyst sample in the reactor for about 4 minutes of O₂ residence time. Subsequently, the feed flow may be switched to CO to flow through the catalyst sample in the reactor for about another 4 minutes of CO residence time, enabling the isothermal oscillating condition between CO and O₂ flows during a total time of about 1,000 seconds. Additionally, O₂ and CO may be allowed to flow in the empty test reactor not including the catalyst sample. Subsequently, testing may be performed allowing O₂ and CO to flow in the test tube reactor including a fresh ZPGM catalyst sample and observe/measure the OSC property of the catalyst sample. As the catalyst sample may have OSC property, the catalyst sample may store O₂ when O₂ flows. Subsequently, when CO may flow, there is no O₂ flowing, and the O₂ stored in the catalyst sample may react with the CO to form CO₂. The time during which the catalyst sample may store O₂ and the time during which CO may be oxidized to form CO₂ may be measured.

The following examples are intended to illustrate the scope of the disclosure. It is to be understood that other procedures known to those skilled in the art may alternatively be used. Examples in the present disclosure may be prepared according to variations of base metal loadings of Cu and Mn for IMP layer 108 of Cu_{1.0}Mn_{2.0}O₄ spinel as shown in Table 1.

TABLE 1

| Base Metal | Cu | Mn |
|---|---|---|
| Loading Ratio | [% wt] | [% wt] |
| 0.75X | 8.9 | 15.3 |
| 1.00X | 11.8 | 20.4 |
| 1.25X | 14.8 | 25.5 |
| 1.50X | 17.7 | 30.6 |
| 2.00X | 23.6 | 40.8 |

### Examples

### Example #1

### ZPGM Catalyst Samples Including Cu_{1.0}Mn_{2.0}O₄ Spinel Type 1 (0.75× Loading)

Example #1 may illustrate preparation of fresh ZPGM catalyst samples of catalyst configuration 100 employing a coating process including impregnation technique for IMP layer 108 of Cu_{1.0}Mn_{2.0}O₄ spinel, here referred as Cu_{1.0}Mn_{2.0}O₄ spinel Type 1, on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then, OC layer 106 may be coated on WC layer 102, followed by calcination at 550° C. for about 4 hours. Subsequently, for Cu_{1.0}Mn_{2.0}O₄ spinel Type 1, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, where suitable copper loading may be about 8.9% by weight and suitable manganese loading may be about 15.3% by weight. Then, Cu—Mn solution may be impregnated to OC layer 106, followed by firing at about 600° C. for about 5 hours.

The NO/CO cross over R-value for fresh ZPGM catalyst samples may be determined by performing isothermal steady state sweep test at about 450° C., and testing a gas stream at R-values from about 1.40 (rich condition) to about 0.80 (lean condition) to measure the CO, NO, and HC conversions.

The oxygen storage capacity (OSC) property of disclosed ZPGM catalyst system including IMP layer 108 of Cu_{1.0}Mn_{2.0}O₄ spinel Type 1 may be determined using CO and O₂ pulses under isothermal oscillating condition, referred as OSC test, to determine O₂ and CO delay times and to verify the influence on activity that may result from variations of the base metal loadings of Cu and Mn.

### Example #2

### ZPGM Catalyst Samples Including Cu_{1.0}Mn_{2.0}O₄ Spinel Type 2 (1.00× Loading)

Example #2 may illustrate preparation of fresh ZPGM catalyst samples of catalyst configuration 100 employing a coating process including impregnation technique for IMP layer 108 of Cu_{1.0}Mn_{2.0}O₄ spinel, here referred as Cu_{1.0}Mn_{2.0}O₄ spinel Type 2, on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then, OC layer 106 may be coated on WC layer 102, followed by calcination at 550° C. for about 4 hours. Subsequently, for Cu_{1.0}Mn_{2.0}O₄ spinel Type 2, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, where the suitable copper loading may be about 11.8% by weight and suitable manganese loading may be about 20.4% by weight. Then, Cu—Mn solution may be impregnated to OC layer 106, followed by firing at about 600° C. for about 5 hours.

The NO/CO cross over R-value for fresh ZPGM catalyst samples may be determined by performing isothermal steady state sweep test at about 450° C., and testing a gas stream at R-values from about 1.40 (rich condition) to about 0.80 (lean condition) to measure the CO, NO, and HC conversions.

The oxygen storage capacity (OSC) property of disclosed ZPGM catalyst system including IMP layer 108 of Cu_{1.0}Mn_{2.0}O₄ spinel Type 2 may be determined using CO and O₂ pulses under isothermal oscillating condition, referred as OSC test, to determine O₂ and CO delay times and to verify the influence on activity that may result from variations of the base metal loadings of Cu and Mn.

### Example #3

### ZPGM Catalyst Samples Including Cu_{1.0}Mn_{2.0}O₄ Spinel Type 3 (1.25× Loading)

Example #3 may depict preparation of fresh samples of catalyst configuration 100 employing a coating process including impregnation technique for IMP layer 108 of Cu_{1.0}Mn_{2.0}O₄ spinel, Cu_{1.0}Mn_{2.0}O₄ spinel Type 3, on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then, OC layer 106 may be coated on WC layer 102, followed by calcination at 550° C. for about 4 hours. Subsequently, for Cu_{1.0}Mn_{2.0}O₄ spinel Type 3, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, where the suitable copper loading may be about 14.8% by weight and suitable manganese loading may be about 25.5% by weight. Then, Cu—Mn solution may be impregnated to OC layer 106, followed by firing at about 600° C. for about 5 hours.

The NO/CO cross over R-value for fresh ZPGM catalyst samples may be determined by performing isothermal steady state sweep test at about 450° C., and testing a gas stream at R-values from about 1.40 (rich condition) to about 0.80 (lean condition) to measure the CO, NO, and HC conversions.

The oxygen storage capacity (OSC) property of disclosed ZPGM catalyst system including IMP layer 108 of Cu_{1.0}Mn_{2.0}O₄ spinel Type 3 may be determined using CO and O₂ pulses under isothermal oscillating condition, referred as OSC test, to determine O₂ and CO delay times and to verify the influence on activity that may result from variations of the base metal loadings of Cu and Mn.

### Example #4

### ZPGM Catalyst Samples Including Cu_{1.0}Mn_{2.0}O₄ Spinel Type 4 (1.50× Loading)

Example #4 may depict preparation of fresh samples of catalyst configuration 100 employing a coating process including impregnation technique for IMP layer 108 of Cu_{1.0}Mn_{2.0}O₄ spinel, here referred as Cu_{1.0}Mn_{2.0}O₄ spinel Type 4, on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then, OC layer 106 may be coated on WC layer 102, followed by calcination at 550° C. for about 4 hours. Subsequently, for Cu_{1.0}Mn_{2.0}O₄ spinel Type 4, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, where the suitable copper loading may be about 17.7% by weight and suitable manganese loading may be about 30.6% by weight. Then, Cu—Mn solution may be impregnated to OC layer 106, followed by firing at about 600° C. for about 5 hours.

The NO/CO cross over R-value for fresh ZPGM catalyst samples may be determined by performing isothermal steady state sweep test at about 450° C., and testing a gas stream at R-values from about 1.40 (rich condition) to about 0.80 (lean condition) to measure the CO, NO, and HC conversions.

The oxygen storage capacity (OSC) property of disclosed ZPGM catalyst system including IMP layer 108 of Cu_{1.0}Mn_{2.0}O₄ spinel Type 4 may be determined using CO and O₂ pulses under isothermal oscillating condition, referred as OSC test, to determine O₂ and CO delay times and to verify the influence on activity that may result from variations of the base metal loadings of Cu and Mn.

### Example #5

### ZPGM Catalyst Samples Including Cu_{1.0}Mn_{2.0}O₄ Spinel Type 5 (2.00× Loading)

Example #5 may depict preparation of fresh samples of catalyst configuration 100 employing a coating process including impregnation technique for IMP layer 108 of Cu_{1.0}Mn_{2.0}O₄ spinel, here referred as Cu_{1.0}Mn_{2.0}O₄ spinel Type 5, on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then, OC layer 106 may be coated on WC layer 102, followed by calcination at 550° C. for about 4 hours. Subsequently, for Cu_{1.0}Mn_{2.0}O₄ spinel Type 5, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, where the suitable copper loading may be about 23.6% by weight and suitable manganese loading may be about 40.8% by weight. Then, Cu—Mn solution may be impregnated to OC layer 106, followed by firing at about 600° C. for about 5 hours.

The NO/CO cross over R-value for fresh ZPGM catalyst samples may be determined by performing isothermal steady state sweep test at about 450° C., and testing a gas stream at R-values from about 1.40 (rich condition) to about 0.80 (lean condition) to measure the CO, NO, and HC conversions.

The oxygen storage capacity (OSC) property of disclosed ZPGM catalyst system including IMP layer 108 of Cu_{1.0}Mn_{2.0}O₄ spinel Type 5 may be determined using CO and O₂ pulses under isothermal oscillating condition, referred as OSC test, to determine O₂ and CO delay times and to verify the influence on activity that may result from variations of the base metal loadings of Cu and Mn.

Analysis of Influence of Variations of Base Metal Loadings on TWC Performance

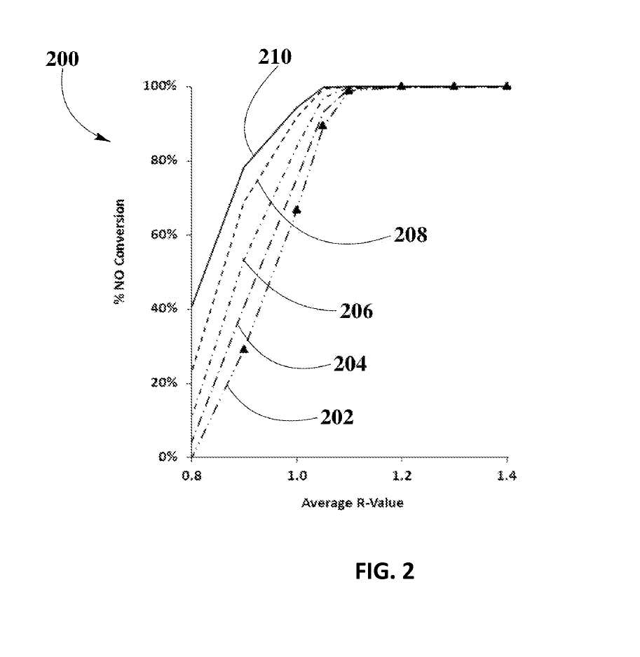

FIG. 2 depicts NOX conversion comparison 200 for fresh ZPGM catalyst samples prepared by impregnation of Cu—Mn spinel of different base metal loadings, under isothermal steady state sweep condition at inlet temperature of about 450° C. and space velocity (SV) of about 40,000 h⁻¹, according to an embodiment.

In FIG. 2, conversion curve 202 (double dot-long dash line) shows NO_{X} conversion for fresh ZPGM catalyst samples prepared per example #1; conversion curve 204 (single dot-long dash line) represents NO_{X} conversion for fresh ZPGM catalyst samples prepared per example #2; conversion curve 206 (single dot-short dash line) depicts NO_{X} conversion for fresh ZPGM catalyst samples prepared per example #3; conversion curve 208 (short dash line) illustrates NO_{X} conversion for fresh ZPGM catalyst samples prepared per example #4; and conversion curve 210 (solid line) shows NO_{X} conversion for fresh ZPGM catalyst samples prepared per example #5.

As may be seen in FIG. 2, as base metal loadings increase from 0.75× to 2.00× according to Table 1, NO_{X} conversion significantly improves. This improvement occurs in lean region (R-value<1.0). The higher NO_{X} conversion level may be observed for fresh ZPGM catalyst samples including IMP layer 108 of Cu_{1.0}Mn_{2.0}O₄ spinel Type 5 (base metal loading ratio of 2.00×, Cu loading of 23.6% by weight and Mn loading of 40.8% by weight).

The improvements in lean NO_{X} conversion with increasing base metal loadings may be confirmed with the results from isothermal steady state sweep test for fresh ZPGM catalyst samples prepared per example #1, example #2, example #3, example #4, and example #5 with base metal loading of 0.75×, 1.00×, 1.25×, 1.50×, and 2.00×, respectively according to Table 1.

For fresh ZPGM catalyst samples including Cu_{1.0}Mn_{2.0}O₄ spinels Type 1, Type 2, Type 3, Type 4, and Type 5, observed NO/CO cross over R-values are 1.13, 1.10, 1.09, 1.06, and 1.05, respectively. These R-values (rich condition under close to stoichiometric condition) verify the influence that variations of base metal loadings may have on TWC performance, showing that fresh ZPGM catalyst samples including IMP layer 108 of Cu_{1.0}Mn_{2.0}O₄ spinel Type 5 (base metal loading ratio of 2.00×, Cu loading of 23.6% by weight and Mn loading of 40.8% by weight) provide significant improvement on TWC performance, at lower R-value of 1.05 (about stoichiometric condition).

Significant high lean NO_{X} conversion may also be observed from FIG. 2, where fresh ZPGM catalyst samples, prepared per example #1, example #2, example #3, example #4, and example #5, at R-value of about 0.95 (lean condition) may have a NO_{X} conversion of 29.11%, 40.72%, 53.28%, 68.84%, and 78.36% by increasing base metal loadings from 0.75× to 1.00×, 1.25×, 1.50× and 2.00× respectively.

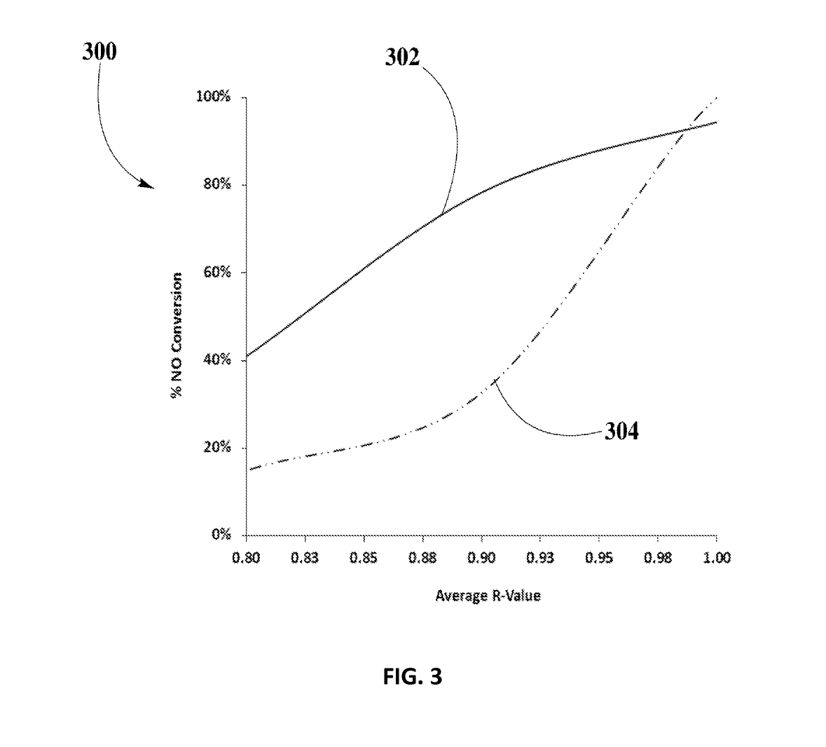

FIG. 3 illustrates NOX conversion comparison 300 under lean condition for fresh ZPGM catalyst samples prepared per example #5 with 2.00× base metal loading and fresh samples of commercial PGM catalyst, under isothermal steady state sweep condition at inlet temperature of about 450° C. and space velocity (SV) of about 40,000 h⁻¹, according to an embodiment.

In this embodiment, fresh samples of commercial PGM catalyst may be a catalyst including OC layer of Pd loading of about 6 g/ft³ and Rhodium (Rh) loading of about 6 g/ft³ with alumina-based support oxide and about 30% to about 40% by weight of oxygen storage material. WC layer includes alumina-based support oxide and oxygen storage material.

In FIG. 3, conversion curve 302 (solid line) represents NO_{X} conversion for fresh ZPGM catalyst samples prepared per example #5 and conversion curve 304 (double dot-long dash line) illustrates NO_{X} conversion for fresh commercial PGM catalyst samples.

The comparison of lean NO_{X} conversion levels may be carried out using isothermal steady state sweep test R-values from about 1.00 (stoichiometric condition) to about 0.80 (lean condition).

As may be seen in FIG. 3, fresh ZPGM catalyst samples with 2.00× base metal loading, per example #5, show significant improvement of NO_{X} conversion, under lean condition, when compared with NO_{X} conversion, under lean condition, of fresh samples of commercial PGM catalyst. At R-value of about 0.90, about 32.6% NO_{X} conversion level may be noted for fresh samples of commercial PGM catalyst, while about 78.36% NO_{X} conversion level may be noted for fresh ZPGM catalyst samples, per example #5. At R-value of about 0.95, about 61.90% NO_{X} conversion level may be noted for fresh samples of commercial PGM catalyst, while about 88.60% NO_{X} conversion level may be noted for fresh ZPGM catalyst samples, per example #5.

Since it is desirable to increase catalytic activity under lean condition, NO_{X} conversion may be increased by increasing base metal loadings, as it was observed in NO_{X} conversion comparison for all fresh ZPGM catalyst samples prepared according to principles in present disclosure (FIG. 2). The influence of variations of base metal loadings improves fuel consumption and provide fuel economy. As may be observed, fresh ZPGM catalyst samples, per example #5 show significant improvement toward lean condition that surpasses performance of PGM catalyst samples because of high NO_{X} conversion realized under lean condition, which may also lead to lower fuel consumption.

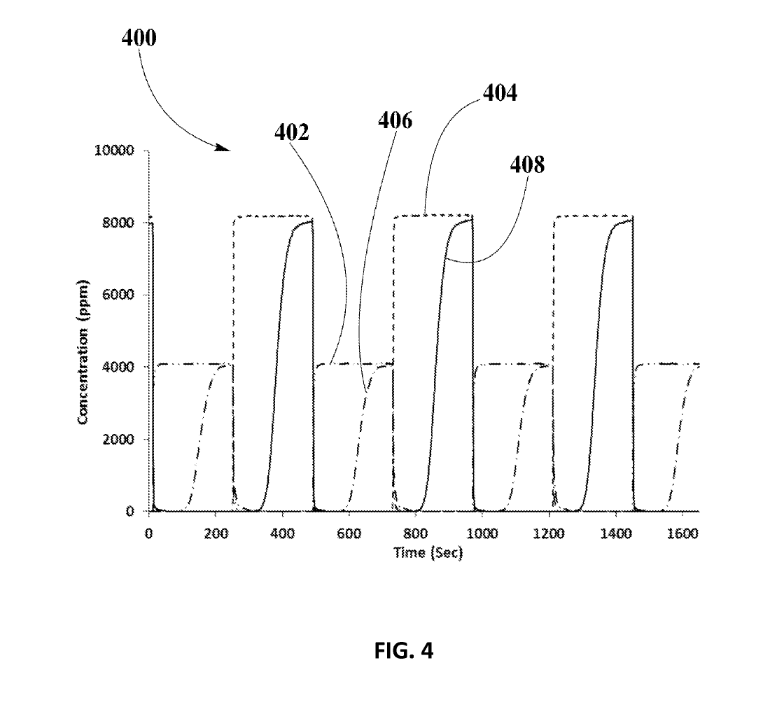

FIG. 4 shows OSC isothermal oscillating test 400 for a fresh ZPGM catalyst samples with base metal loading of 2.00×, per example #5, at temperature of about 575° C., according to an embodiment.

In FIG. 4, curve 402 (double-dot dashed graph) shows the result of flowing 4,000 ppm O₂ through an empty test reactor which may be used for OSC isothermal oscillating test 400; curve 404 (dashed graph) depicts the result of flowing 8,000 ppm CO through the empty test reactor; curve 406 (single-dot dashed graph) shows the result of flowing 4,000 ppm O₂ through the test reactor including fresh ZPGM catalyst sample, per example #5; and curve 408 (solid line graph) depicts the result of flowing 8,000 ppm CO through the test reactor including fresh ZPGM catalyst sample, per example #5.

It may be observed in FIG. 4 that the O₂ signal in presence of fresh ZPGM catalyst sample, per example #5, as shown in curve 406, does not reach the O₂ signal of empty reactor shown in curve 402. This result indicates the storage of a large amount of O₂ in the fresh ZPGM catalyst sample, per example #5. The measured O₂ delay time, which is the time required to reach an O₂ concentration of 2,000 ppm (50% of feed signal), in presence of fresh ZPGM catalyst sample, per example #5, is about 136.17 seconds. The O₂ delay time measured from OSC isothermal oscillating test 400 indicates that fresh ZPGM catalyst sample, per example #5, has a significantly high OSC property when compared with O₂ delay time of about 11.73 seconds, measured from OSC isothermal oscillating test, of commercial PGM catalyst sample including OSM.

Similar result may be observed for CO. As may be seen, the CO signal in presence of fresh ZPGM catalyst sample, per example #5, shown in curve 408, does not reach the CO signal of empty reactor shown in curve 404. This result indicates the consumption of a significant amount of CO by fresh ZPGM catalyst sample, per example #5, and desorption of stored O₂ for the conversion of CO to CO₂. The measured CO delay time, which is the time required to reach to a CO concentration of 4,000 ppm, in the presence of fresh ZPGM catalyst sample, per example #5, is about 127.70 seconds. The CO delay time measured from OSC isothermal oscillating test 400 shows that fresh ZPGM catalyst sample, per example #5, has significantly high OSC property when compared with CO delay time of about 9.31 seconds, measured from OSC isothermal oscillating test, of commercial PGM catalyst sample including OSM.

The measured O₂ delay time and CO delay times may be an indication that fresh ZPGM catalyst samples with base metal loading of 2.00×, per example #5, may exhibit enhanced oxygen storage capacity as compared to commercial PGM catalysts including OSM. As may be seen in FIG. 4, significant OSC property of ZPGM catalysts, per example #5, may explain the significantly high NO_{X} conversion under lean condition Fas compared with PGM catalysts.

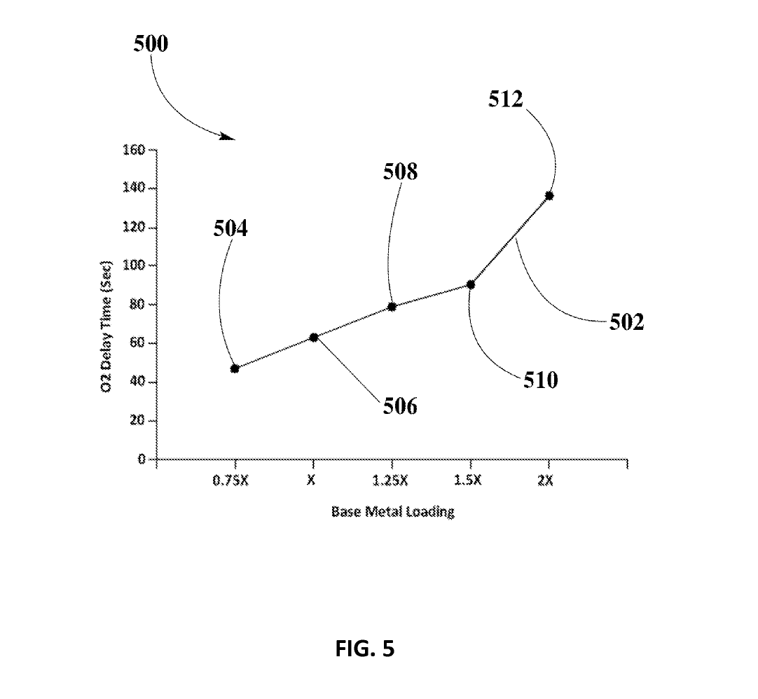

FIG. 5 shows comparison of O₂ delay time results from OSC isothermal oscillating tests 500 performed at 575° C., for fresh ZPGM catalyst samples prepared by impregnation of stoichiometric Cu—Mn spinel of different base metal loadings, according to an embodiment.

In FIG. 5, curve 502 shows O₂ delay time results for fresh ZPGM catalyst samples per example #1, represented in point 504; fresh ZPGM catalyst samples per example #2, depicted in point 506; fresh ZPGM catalyst samples per example #3, illustrated in point 508; fresh ZPGM catalyst samples per example #4, shown in point 510; and fresh ZPGM catalyst samples per example #5, represented in point 512.

As may be seen in FIG. 5, at point 504, O₂ delay time of about 46.00 seconds was obtained for fresh ZPGM catalyst samples per example #1, with base metal loading of 0.75×, and increased to 136.17 seconds for ZPGM catalysts with base metal loading of 2.00×. These results indicate that, according to principles in present disclosure, OSC property of prepared fresh ZPGM catalyst samples increases by increasing base metal loadings, which also explain the noted improvement in NO_{X} conversion, as shown in FIG. 2. Even ZPGM catalysts with lower base metal loading, catalyst samples per example #1 with 0.75× loading, show improvement on OSC property as compared to commercial PGM catalyst.

As a result of increasing Cu—Mn base metal loadings, improvements in TWC performance and oxygen storage capacity may be realized at higher base metal loading ratios, which may be used to prepare an impregnation layer of Cu_{1.0}Mn_{2.0}O₄ spinel in ZPGM catalysts for TWC applications.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic system, comprising:
a substrate;
a washcoat applied to said substrate comprising alumina;
an overcoat applied to said washcoat comprising at least one support oxide comprising doped ZrO₂ and at least one impregnation layer of Cu—Mn spinel; and
at least one catalyst applied to the at least one support oxide;
wherein the at least one catalyst is substantially free of platinum group metals.

2. The catalyst system of claim 1, wherein the doped ZrO₂ comprises ZrO₂—Pr₆O₁₁.

3. The catalyst system of claim 1, wherein the Cu—Mn spinel had a general formula of Cu_{1.0}Mn_{2.0}O₄.

4. The catalyst system of claim 1, wherein the Cu—Mn spinel comprises about 8.9% by weight Cu and about 15.3% by weight Mn.

5. The catalyst system of claim 4, wherein the oxygen storage capacity is higher than a standard platinum group metal catalyst.

6. The catalyst system of claim 4, wherein the O₂ delay time is about 46.00 seconds.

7. The catalyst system of claim 1, wherein the Cu—Mn spinel comprises about 11.8% by weight Cu and about 20.4% by weight Mn.

8. The catalyst system of claim 1, wherein the Cu—Mn spinel comprises about 14.8% by weight Cu and about 25.5% by weight Mn.

9. The catalyst system of claim 1, wherein the Cu—Mn spinel comprises about 17.7% by weight Cu and about 30.6% by weight Mn.

10. The catalyst system of claim 1, wherein the Cu—Mn spinel comprises about 23.6% by weight Cu and about 40.8% by weight Mn.

11. The catalyst system of claim 10, wherein the oxygen storage capacity is higher than a standard platinum group metal catalyst.

12. The catalyst system of claim 10, wherein the O₂ delay time is greater than 135 seconds.

13. The catalyst system of claim 1, wherein the substrate comprises ceramics.

14. The catalyst system of claim 1, wherein the conversion of NOₓ increases with an increasing amount of Cu—Mn spinel.

15. The catalyst system of claim 1, wherein the NO/CO cross over increases with an increasing amount of Cu—Mn spinel.

16. The catalyst system of claim 1, wherein the catalytic performance under lean conditions increases with an increasing amount of Cu—Mn spinel.

17. The catalyst system of claim 1, wherein engine performance under lean conditions increases with an increasing amount of Cu—Mn spinel.

18. The catalyst system of claim 1, wherein the CO delay time is greater than 120 seconds.
